(19) United States
(12) Patent Application Publication
(10) Pub. No.: US 2026/0017753 A1
(43) Pub. Date: Jan. 15, 2026

(54) SUPER-RESOLUTION ANALYSIS SYSTEM AND METHOD, AND CORRESPONDING IMAGING DEVICE AND MODEL TRAINING METHOD

(71) Applicant: MGI TECH CO., LTD., Shenzhen (CN)

(72) Inventors: Yinchuan ZHANG, Shenzhen (CN); Liyan SONG, Shenzhen (CN); Le WANG, Shenzhen (CN)

(21) Appl. No.: 18/995,100

(22) PCT Filed: Aug. 30, 2022
(86) PCT No.: PCT/CN2022/115924

§ 371 Date: Jan. 15, 2025

(51) Int. Cl. G06T 3/4046; G01N 21/64; G06T 3/4053

(52) U.S. Cl. CPC G06T 3/4046; G01N 21/6402; G01N 21/6428; G01N 21/6458; G06T 3/4053; G01N 2021/6439

(57) ABSTRACT

The present application pertains to the technical field of image processing and artificial intelligence, and discloses a deep learning-based super-resolution analysis system and method. The super-resolution analysis system includes an analysis unit, which includes a super-resolution realization model and can be executed by a processor for constructing a super-resolution image based on an input wide-field image; wherein the super-resolution realization model is a trained deep learning model, and a training dataset for training the super-resolution realization model and the input wide-field image originate from one and the same imaging module. The present application further discloses a corresponding imaging device and model training method. According to the present application, with only the need of reconstructing a wide-field image, a super-resolution image based on a mapping relationship can be output via a deep learning algorithm, thus reducing the number of images to get acquired, achieving improved resolution without additionally time increase.

### TECHNICAL FIELD

The present application relates to the technical field of image processing and artificial intelligence, and more specifically, provides a deep learning-based super-resolution analysis system and method and corresponding imaging device and model training method.

### BACKGROUND

The cost of gene sequencing for personal genome has hovered around USD1,000 for five years and cannot continue to decline significantly. This is because the internationally mainstream high-throughput gene sequencing technology (second-generation gene sequencing technology) is based on traditional optical microscopes, and its resolution is limited by the “optical diffraction limit”, and the sample spacing can only be controlled above 500 nm (objective lens NA=1.0). This limits further improvement of gene sequencing throughput according to the “Super Moore's Law”, and it is imperative to develop a new high-throughput gene sequencing technology.

Gene sequencing throughput mainly depends on resolution, objective field of view and camera speed. The objective field of view and camera speed are limited by the existing optical design/processing technology and semiconductor technology respectively, and are difficult to get breakthrough. Modern optical super-resolution technology can break the constraint of the “optical diffraction limit” from the perspective of interaction of light with matter, and achieve super-resolution. Super-resolution is to improve the resolution of an original image through a hardware or software method. The process of obtaining a high-resolution image through a series of low-resolution images is namely super-resolution reconstruction.

Since gene sequencing throughput, reagent and consumable costs, ect., are inversely proportional to the square of sample array density, a key issue that needs to be urgently studied in the field of sequencing device research and development is how to increase the sample array density on a sequencing chip by a super-resolution technology, thereby promoting the reduction of sequencing cost according to the “Super Moore's Law”. Currently, there is a super-resolution technology for high-throughput gene sequencing: structured illumination super-resolution fluorescence microscopy technology. This technology can improve the resolution by about two times simply by improving lighting and the method. However, the core of super-resolution technology, i.e., high-density stripe structured illumination and fast image reconstruction algorithm, is still to be broken through, in order to be workable for high-throughput gene sequencing.

### SUMMARY

An object of the present application is to propose a deep learning-based resolution enhancement method, which enables, by acquiring a wide-field image, obtainment of a corresponding super-resolution image, so as to achieve the purpose of improving spatial resolution without additionally increasing image acquisition time, and whose application to a sequencer can improve sequencing throughput.

In a first aspect, the present application provides a super-resolution analysis system, comprising an analysis unit, the analysis unit comprising a super-resolution realization model, the analysis unit being capable of being executed by a processor for constructing a super-resolution image based on an input wide-field image, wherein the super-resolution realization model is a trained deep learning model, and a training dataset for training the super-resolution realization model and the input wide-field image originate from one and the same imaging module.

In one embodiment, the analysis unit comprises:
a receiving module for receiving the wide-field image from the imaging module;
a processing module connected to the receiving module and configured for implementing the super-resolution realization model and constructing the super-resolution image based on the wide-field image.

In a second aspect, the present application provides an imaging device, comprising an imaging module and the analysis system described in the first aspect of the present application, the super-resolution realization model being trained with a training dataset from the imaging module.

In a third aspect, the present application provides a super-resolution analysis method, comprising:
1) obtaining a wide-field image from an imaging module;
2) constructing a super-resolution image based on the wide-field image through a super-resolution realization model, wherein the super-resolution realization model is a trained deep learning model, and a training dataset for training the super-resolution realization model originates from the imaging module.

In a fourth aspect, the present application provides a training method for a super-resolution realization model, comprising:
1) obtaining at least one set of wide-field images and super-resolution images from an imaging module to form a training dataset;
2) completing training of feature parameters of a deep learning model based on the training dataset, and obtaining a super-resolution realization model for the imaging module based on trained feature parameters.

In one embodiment, the super-resolution image is obtained by:
1) collecting fluorophore signals of a target sample over time using single-molecule localization technology, and creating a super-resolution image by integrating the fluorophore signals;
2) constructing phase and amplitude images for a target sample in a wide-field light source using structured illumination microscopy, and creating a super-resolution image by integrating multiple phase and amplitude images; or
3) exciting fluorescence from a target sample by two lasers through stimulated emission depletion microscopy, wherein one of the two lasers is operated to excite fluorophore(s) and the other is operated to emit a laser beam to deplete emission from the same fluorophore(s), thereby forming images of local captured areas, and creating a super-resolution image by integrating the images of local captured areas.

In the present application, with only the need of reconstructing a wide-field image, a super-resolution image based on a mapping relationship can be output via a deep learning algorithm, thus reducing the number of images to get acquired and truly achieving improved resolution without additionally time increase. The present application can be compatible with the existing non-super-resolution methods, merely by importing a trained model into a non-super-resolution system to likewise achieve super-resolution effects by the non-super-resolution system, on the condition of unified parameters and unified device types.

### BRIEF DESCRIPTION OF THE DRAWINGS

In order to more clearly illustrate specific implementations of the present application or the technical solution(s) in the related art, figures required for use in the description of the specific implementations or the related art will be briefly introduced below. Apparently, the figures described below are some implementations of the present application, and for those skilled in the art, based on these figures, other figures can be obtained without creative work.

FIG. 1 shows a schematic diagram of a super-resolution analysis system according to an embodiment of the present application.

FIG. 2 shows a schematic diagram of an imaging system according to an embodiment of the present application.

FIG. 3 shows a traditional super-resolution algorithm in a sequencer and a deep learning algorithm model based on an embodiment of the present application.

FIG. 4 shows a super-resolution reconstruction algorithm model in an implementation.

FIG. 5 shows a schematic diagram of the training process of a super-resolution realization model according to an embodiment of the present application.

FIG. 6 shows a solution for constructing a training dataset according to an embodiment of the present application.

FIG. 7 shows an exemplary deep learning model used in an example of the present application adopting a Transformer-based architecture.

FIG. 8 shows an example in which a wide-field image (a. ordinary wide-field microscopy) is input into a trained deep learning model, and the corresponding super-resolution image (c) is output; b is a structured illumination microscopy super-resolution image for comparison.

FIG. 9 shows a comparison of the imaging resolution performance of different methods under the same imaging condition.

### DETAILED DESCRIPTION

In order to make the above and other features and advantages of the present application clearer, the present application is further described below in conjunction with the accompanying drawings. The accompanying drawings constitute a part of the present application, and together with examples of the present application, are used to explain the present application. For clarity and simplicity, a specific detailed description of a known function and structure of a device described herein will be omitted when it may obscure the subject matter of the present application. It should be understood that specific examples given herein are for the purpose of explaining to those skilled in the art and are merely illustrative, but not limitative. For those skilled in the art, specific meaning of a term in the present application can be understood according to the specific circumstances, unless the term is otherwise clearly defined.

In the following description, numerous specific details are set forth in order to provide a thorough understanding of the present application. However, it will be apparent to those skilled in the art that the specific details need not to be employed to practice the present application. In other instances, well-known steps or operations are not described in detail in order to avoid obscuring the present application.

An object of the present application is to propose a deep learning-based resolution enhancement solution, to obtain a super-resolution image through a wide-field image. Therefore, the solution proposed in the present application can be used to realize a deep learning-based super-resolution imaging gene detection method with high spatiotemporal resolution that only requires a wide-field image (such as a fluorescence microscopy image), overcoming the problems that the resolution is restricted by the diffraction limit in gene detection imaging, structured illumination super-resolution imaging requires collection of a large amount of data, and the reconstruction speed is restricted. The solution of the present application can significantly improve the data throughput of gene detection without losing details and imaging field of view, while reducing the risk of photobleaching and phototoxic contamination to a genetic sample by illumination light. As compared with the structured illumination-based super-resolution reconstruction method, the solution of the present application can obtain consistent, authentic and credible super-resolution reconstruction results.

Without wishing to be bound by any theory, the present application has found that due to the differences in optical systems, noise, etc., between different imaging modules, the optical systems of different imaging modules have their own individual characteristics, and it is often difficult for a model obtained by learning with the data of one optical system to obtain relatively good results on another optical system, even for imaging systems of the same model that are produced as the same batch. This is especially true for the optical systems of imaging modules equipped in gene sequencing systems. The deep learning algorithm of the super-resolution imaging system proposed in the present application is to perform training based on image data provided by one and the same imaging module, and then perform reconstruction based on the specific imaging module, and the reconstruction result is stable, authentic and credible. According to verification testing, as long as it is guaranteed that a hardware system that affects this imaging module remains unchanged, a wide-field image can be directly captured in the future and a super-resolution image can be generated through this model. If the hardware system needs to be replaced, the deep learning algorithm of the super-resolution imaging system proposed in the present application can be used again for training.

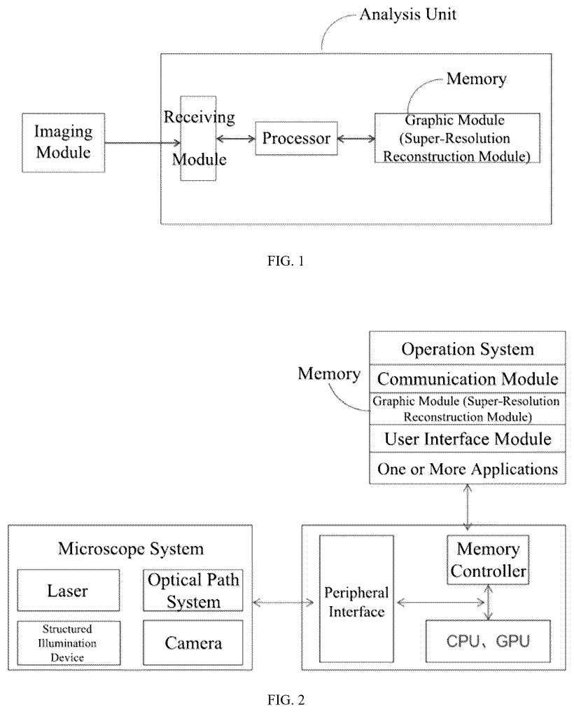

In the present application, the proposed super-resolution analysis system may comprise an analysis unit, which comprises a super-resolution realization model. The analysis unit can be executed by a processor for constructing a super-resolution image based on an input wide-field image, wherein the super-resolution realization model is a trained deep learning model, and a training dataset for training the super-resolution realization model and the input wide-field image originate from one and the same imaging module. FIG. 1 shows a schematic diagram of a super-resolution analysis system according to an embodiment of the present application. In FIG. 1, the analysis unit receives a wide-field image from an imaging module and constructs a super-resolution image based on the received wide-field image. Optionally, as shown in FIG. 1, the analysis unit may comprise a receiving module, a processor, and a memory in which a graphics module, i.e., a super-resolution reconstruction module, is loaded. The processor and the memory constitute a processing module. The receiving module is configured to receive the wide-field image, and the processing module is configured to realize the super-resolution realization model and construct the super-resolution image based on the wide-field image. The receiving module communicates with the imaging module through a wired interface or a wireless interface to receive the wide-field image data generated by the imaging module. The processing module is connected to the receiving module and obtains the wide-field image data from the receiving module for subsequent analysis. The processing module comprises a CPU (or GPU), and the memory in which computer code of a deep learning model is loaded, and the deep learning model comprises parameters obtained through training. The CPU (or GPU) obtains the corresponding super-resolution image based on the wide-field image obtained by the receiving module as well as the computer code and related trained parameters of the deep learning model.

In the present application, the super-resolution analysis system may be independent of the imaging module system, or may be combined with the imaging module system to form an integrated imaging system. The independent super-resolution analysis system may be independent at the hardware system level, for example, the super-resolution analysis system is run by an independent processor and especially comprises an independent memory. An independent super-resolution analysis system can communicate with the imaging module through a wired interface or a wireless interface to receive a wide-field image data generated by the imaging module. The wired interface includes, but is not limited to, a standard serial port (RS232), Ethernet, and USB. The protocol utilized by the wireless interface includes, but is not limited to, LoRa, NB-IoT, ZigBee, WiFi, Bluetooth, and BLE. Optionally, the super-resolution analysis system sends a request to the imaging module system, requesting for a wide-field image, and the imaging module system sends the wide-field image to the super-resolution analysis system. Likewise, the super-resolution analysis system can be in the same hardware system with the imaging module system. For example, the super-resolution analysis system is deployed as a graphics module in the imaging system, sharing the processor and memory with the imaging module. During the operation of the super-resolution analysis system, the wide-field image generated by the imaging module is called through computer instructions. In the present application, the wide-field image generated by the imaging module can be directly transmitted to the super-resolution analysis system; alternatively, the wide-field image generated by the imaging module can be stored in a storage device and transmitted to the super-resolution analysis system upon receipt of a request or based on other trigger conditions.

In the present application, the imaging module can image different types of light. In an example, the imaging module can be an ordinary optical microscope that utilizes a natural light source. In another example, the imaging module images light of a specific wavelength, and for example is a fluorescence microscope that utilizes laser excited fluorescence. For a fluorescence microscope, the imaging module may comprise different light sources. For example, the light sources may comprise an ultra-high pressure mercury lamp and a filter system, the high pressure mercury lamp produces strong light, which contains therein a large amount of ultraviolet light and blue-violet light, and monochromatic light is produced through the filter system. The light sources may also comprise a natural light source, which has the same function as an ordinary optical microscope. The imaging module may comprise an excitation filter for filtering a portion of visible light in the light source and providing excited light of a certain wavelength. The imaging module may comprise a blocking filter for transmitting fluorescence in a corresponding wavelength range and blocking or absorbing the remaining excited light. The imaging module may comprise a dichroic mirror for transmitting long-wavelength light and reflecting short-wavelength light. The imaging module may comprise an aperture stop for determining the resolution and contrast of the microscope image. The imaging module may comprise a field stop for controlling the size of the specimen illumination area and preventing light that is not necessary for image formation from entering the specimen. The imaging module may comprise an excited light converter, also known as a mirror arm rotating stage, which is a disc-shaped structure configured to control the fluorescence excitation mode and the filter combination. The imaging principle of the fluorescence microscope is as follows: first, the light source used in the fluorescence microscope can emit strong ultraviolet light, which passes through the excitation filter to filter out a part of the visible light from the light source; then the ultraviolet light is focused on the sample through a condenser to excite the fluorescent substance on the sample to emit fluorescence; finally, by the blocking filter that follows the objective lens, all the ultraviolet light is prevented from passing, a part of the excess excited light is filtered out, and only the excited fluorescence is allowed to pass, so that what can be observed is the fluorescence emitted by dyed portions of the fluorescent substance.

FIG. 2 shows a schematic diagram of an exemplary imaging system according to the present application. As shown in the figure, the imaging module is a microscope system, including a laser, an optical path system, a camera and a structured illumination device. During sample imaging, the laser emits laser light to the sample, so as to excite fluorescence from the sample, and the fluorescence is then captured by the camera via the optical path system to form a wide-field image. The super-resolution analysis system comprises a processor (CPU, or GPU), and a memory in which a graphics module (super-resolution reconstruction model) is loaded. The super-resolution analysis system further comprises a peripheral interface and a memory controller. The peripheral interface is configured to connect with the microscope system and receive the wide field image formed in the camera from the microscope system. The memory controller is configured to control loading and rewriting of programs and data in the memory. An optional structured illumination device is configured to form structured illumination to generate a super-resolution image of the sample. The structured illumination device can be used in the model training phase, and removed after the model training is completed. The microscope system may share the processor and memory with the analysis system.

In the present application, gene sequencing generally refers to analyzing the base sequence of a specific DNA fragment or RNA fragment, such as determining the arrangement of adenine (A), thymine (T), cytosine (C) and guanine (G). Those skilled in the art can understand that the base sequence includes, but is not limited to, A, C, T, and G, and may also include, for example, rare bases or modified bases. Currently, the fluorescent labeling method is widely used for gene sequencing. The function of the fluorescent imaging module in the gene sequencer is to make laser light excite the fluorescent markers on the gene sequencing chip to produce fluorescence and collect fluorescent signals. The four bases, in combination with different fluorescent markers, produce four fluorescent signals in different bands, which are configured to identify the bases. Therefore, the fluorescence imaging module is a part of the gene sequencer, and is configured to identify and image gene bases, which is workable for both high-throughput and small gene sequencers. FIG. 3 shows an example of applying the model and method of the present application to a sequencing method, showing a traditional super-resolution algorithm and a deep learning algorithm model based on the present application. As compared with the related method, in which for each original base (including, but not limited to, A, C, T and G) channel, six original images need to be collected, and a super-resolution image is obtained through reconstruction and input into the base recognition Basecall algorithm to complete sequencing, based on the method of the present application, only one wide-field image needs to be collected, and a super-resolution image can be directly output through the constructed deep learning model, and then input into the base recognition Basecall algorithm to obtain the sequencing result. As compared with the non-super-resolution method, for the process from the wide-field image to the Basecall, only one step is added, which is to output, from the wide-field image, a new image with higher resolution through the deep learning model, and then input it into the Basecall algorithm. In comparison, it does not add much extra time. In addition, since the key to the method of the present application is to generate the corresponding model of the wide-field image and the super-resolution image, it is basically consistent with the non-super-resolution system in terms of the final embodying form which is operated to input a wide-field image to complete subsequent base identification. Therefore, it only occurs during the data training process to get an actual need of the original image acquisition and the reconstruction of the super-resolution image. Therefore, the solution of the present application is fully compatible with the existing sequencer systems, with the only need of importing a trained model and parameters into the systems before the same leaves the factory, and super-resolution effects can also be produced using a non-super-resolution system.

In the biochemical process of gene sequencing, a sequence of a certain length is first “planted” onto the surface of a sequencing chip through a surface chemical treatment technology. A small area where planting can be performed is called a site, and the distance between adjacent sites is called Pitch. For a non-super-resolution method, the numerical value of this Pitch will generally be greater than the resolution limit of an optical system (λ/(2NA), where λ is the wavelength of light and NA is the numerical aperture of the objective lens; with λ=684.3 nm and NA=0.8 taken as an example, the resolution limit is 427.7 nm, that is, for a system based on this set of optical parameters, the Pitch should be greater than 427.5 nm, and the Pitch with a smaller numerical value cannot be read). Therefore, a sequencing chip can have 1 billion such sites distributed thereon; however, when images are taken, the field of view would not cover the entire chip at one time, but the entire chip is divided into M×N small areas of equal size, and each time uniform light beams are projected onto only a range of an area of this size, and a camera is exposed for a certain period of time to obtain the sequence image of this area, which is a so-called wide field image. When imaging is completed, the fluorescent groups in the existing sequence can be removed through a biochemical reaction, and the removed portion can be washed away. Then a next run of the process of biochemical reaction→imaging→removal can be carried out.

In the present application, a wide-field image refers to an image obtained by an observer or a camera by exposing a target specimen to a light source. A wide-field image is an image obtained by an optically limited system without exceeding the optical diffraction limit and can be captured by a camera and microscope in combination with uniform illumination or unstructured illumination, for example by wide-field microscopy. Wide-field microscopy is a microscopy method that is used very commonly. Almost every laboratory of biological environment-related research institute would be equipped with a wide-field imaging microscope, which is convenient for imaging and has a simple principle. However, the wide-field image does not have a high resolution and involves serious background interference. Wide-field imaging may obtain a fluorescence image, with the fluorescence of the sample triggered by an external laser, where the camera and laser are controlled to turn on simultaneously to capture the corresponding light signal. A wide-field image can be recorded by either CMOS or CCD sensors. For structured illumination microscopy (SIM), a wide-field image can also be obtained by adding 6 original images.

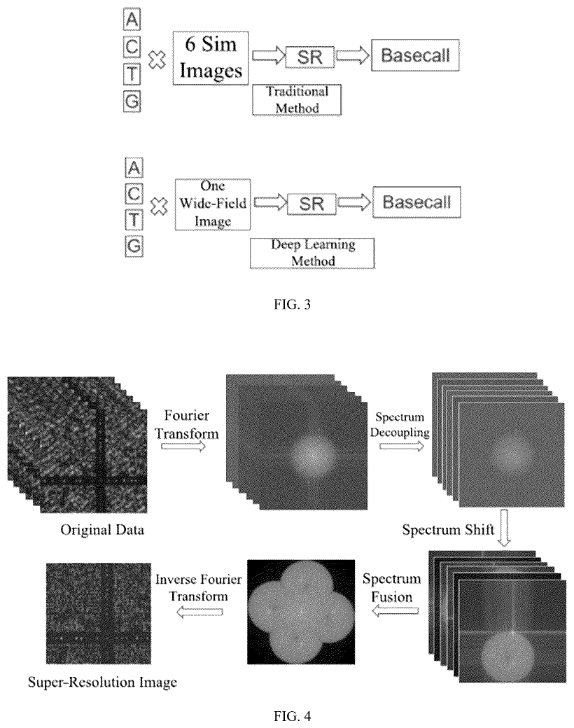

In the present application, a super-resolution image can be obtained by a super-resolution microscope. A super-resolution microscope refers to a microscope with a resolution breaking the resolution limit of an optical microscope, and is a technology that can perform imaging beyond the resolution limit of approximately 200 nm. A super-resolution image can be obtained by laser confocal scanning microscopy, which improves the optical resolution and contrast of a microscopic image by using spatial pinholes to block out-of-focus light. In the image formation process, a laser confocal scanning microscope can capture multiple two-dimensional images at different depths in a sample to reconstruct a three-dimensional structure (this process is called optical slicing). Many super-resolution techniques have been developed in recent years, including Structured Illumination Microscopy (SIM). In the structured illumination microscopy, phase and amplitude patterns are constructed in a wide-field light source, the target sample being imaged will therefore also produce similar patterns, and the interference between the constructed patterns and the sample-based patterns is used to construct intracellular structure. The implementation methods of structured illumination microscopy super-resolution technology are grouped into the following three types according to the core devices that generate structured illumination: mechanical grating (Grating-SIM), spatial light modulator (SLM-SIM) and digital micromirror device (DMD-SIM). Both Grating-SIM and SLM-SIM use collimated parallel light projected onto periodic structures to form first-order (±1) interference fringes on the focal plane as structured illumination. The difference is that Grating-SIM requires use of a rotating device and a piezoelectric translation stage to realize switching of the fringe projection in two directions of X/Y directions and phase shift respectively, while SLM-SIM realizes the direction switching and phase shift by controlling the rotation of loaded liquid crystal molecules. The switching speed of both is relatively slow, both in the order of 100 ms. DMD-SIM also uses an electrical control way to achieve fringe projection in two directions of X/Y directions and phase shift, but it controls the deflection state of each micro-mirror to achieve “bright” and “dark” states. The deflection state is determined by whether a voltage is loaded, so the switching speed can be very fast. However, no matter which method is used, it is necessary to collect two directions×three sets of phases per direction, i.e., a total of 6 original images (X direction: φ_{X1}: 0, φ_{X2}: 2π/3, φ_{X3}: 4π/3; Y direction: φ_{Y1}: 0, φ_{Y2}: 2π/3, φ_{Y3}: 4π/3). A super-resolution image can be constructed using the method as shown in FIG. 4, which shows a schematic diagram of a super-resolution reconstruction algorithm model using six original images. As shown in the figure, a super-resolution image is established from the original data of 6 original images (X direction: φ_{X1}: 0, φ_{X2}: 2π/3, φ_{X3}: 4π/3; Y direction: φ_{Y1}: 0, φ_{Y2}: 2π/3, φ_{Y3}: 4π/3) through Fourier transform, spectrum decoupling, spectrum shift, spectrum fusion and inverse Fourier transform, etc. In the frequency domain, the six original images of structured illumination carry high-frequency and low-frequency components of the sample, the high-frequency and low-frequency components are separated through spectral decoupling, and then moved to correct positions, and finally, spectral fusion is used to restore the frequency components of the sample, thus achieving spectrum spreading. A wide-field image generally only contains low-frequency components. The classic super-resolution reconstruction algorithm requires acquisition of at least three original stripe images in the X/Y direction (X direction: φ_{X1}: 0, φ_{X2}: 2π/3, φ_{X3}: 4π/3; Y direction: φ_{Y1}: 0, φ_{Y2}: 2π/3, φ_{Y3}: 4π/3) to achieve super-resolution reconstruction in both dimensions of X/Y dimensions, and therefore, is a typical technology that sacrifices time for space, which is undoubtedly not cost-effective for sequencing applications. Therefore, it is particularly important to develop a technology that can not only improve the spatial resolution but also does not increase image acquisition time. In the present application, deep learning can extract multi-level features of an image, and besides, a graphics processing unit (GPU) is configured to quickly implement the fitting process of mapping from an input image to an output image, enabling deep learning to be widely used in image classification, semantic segmentation, detection, etc. In the field of SIM super-resolution imaging, reconstruction is often used to reconstruct a super-resolution image from multiple actually-collected stripe structured illumination images (such as three stripe structured illumination images in the X direction, or a total of six stripe structured illumination images in the two directions of X/Y directions). At present, the minimum number of original images required based on this method is three, and no method or instance has been found to achieve super-resolution reconstruction based on a smaller number of images.

Super-resolution techniques that have emerged in recent years further comprise single-molecule localization technology and stimulated emission depletion (STED) microscopy. The single-molecule localization technology uses specific fluorescent molecular probes to mark a target sample, and by changing the external environment where the molecules are located, effectively controls the optical switching characteristics thereof; the spatially overlapping multi-molecule fluorescence images are separated in time into a series of sub-images, so that only a small number of sparsely distributed single molecules emit fluorescence in each frame of sub-image, that is, only one fluorescent molecule is excited within each diffraction limit; thousands of frames of images with randomly distributed fluorescence signals are collected, and the single-molecule localization algorithm is used to accurately locate the center of each molecule; finally, all the located points obtained are superimposed to reconstruct a super-resolution image that breaks the diffraction limit. Stimulated emission depletion (STED) microscopy is a confocal technique that uses two laser beams to simultaneously irradiate a target sample, one of the laser beams is used to excite fluorescent molecules, so that the fluorescent molecules within the Airy disk range of the objective lens focus are in an excited state, and at the same time, the other annular loss laser beam with a central light intensity of zero is superimposed on the fluorescent molecules, so that the fluorescent molecules in the excited state in the edge area of the Airy disk of the objective lens focus return to the ground state through the stimulated radiation depletion process without spontaneously radiating fluorescence; therefore, only the fluorescent molecules in the central area can spontaneously radiate fluorescence, thereby obtaining fluorescence luminescence points beyond the diffraction limit.

The applicant has found that using the deep learning model SwinIR, a corresponding dataset model for an ordinary wide-field images and a super-resolution image can be established, and the dataset model is mainly based on the Transformer architecture. Therefore, the present application realizes comparing and mapping of 6 original images of structured illumination (X direction: φ_{X1}: 0, φ_{X2}: 2π/3, φ_{X3}: 4π/3; Y direction: φ_{Y1}: 0, φ_{Y2}: 2π/3, φ_{Y3}: 4π/3) with the reconstructed super-resolution image by a deep learning model. Through the deep learning model, a correspondence between the wide-field image (low resolution) obtained by adding the 6 original images and the reconstructed super-resolution image (high resolution) is established, so that in subsequent applications, only one wide-field image needs to be reconstructed, and the super-resolution image based on this mapping relationship can be output through the deep learning model, thus reducing the number of images to get acquired and truly achieving improved resolution without additionally time increase.

Therefore, the present application further provides a training system for a super-resolution realization model, including a training unit, which can be executed by a processor for: receiving at least one set of wide-field images and super-resolution images from an imaging module, the at least one set of wide-field images and super-resolution images constituting a training dataset; completing training of feature parameters of a deep learning model based on the training dataset; and determining a super-resolution realization model for the imaging module based on trained feature parameters. The training unit comprises: a receiving module for receiving the at least one set of wide-field images and super-resolution images, the at least one set of wide-field images and super-resolution images constituting the training dataset; a processing module connected to the receiving module, for completing the training of the feature parameters of the deep learning model based on the training dataset. The super-resolution image is obtained by: 1) collecting fluorophore signals of a target sample over time using single-molecule localization technology, and creating the final super-resolution image by integrating a large number of fluorophore signals; 2) constructing phase and amplitude images for a target sample in a wide-field light source using structured illumination microscopy, and creating a super-resolution image by integrating multiple original phase and amplitude images; or 3) exciting fluorescence from a target sample by two lasers through stimulated emission depletion microscopy, wherein one of the two lasers is operated to excite fluorophore(s) and the other is operated to emit a laser beam to deplete emission from the same fluorophore(s), reducing the diffraction area of the fluorescent light spot, significantly improving the resolution of the microscope, thereby forming images of local captured areas, and creating a super-resolution image by integrating the images of local captured areas. The imaging system shown in FIG. 2 can be used as a training system for a super-resolution realization model to complete the training of the super-resolution realization model.

FIG. 5 shows a schematic diagram of the training process of a super-resolution realization model according to an embodiment of the present application. As shown in FIG. 2 and FIG. 5, the microscope system collects a wide-field image and the loaded structured illumination device collects the corresponding six structured illumination microscopic images. By performing super-resolution reconstruction on the six structured illumination microscopy images, the wide-field image and corresponding super-resolution image dataset are obtained and can further work as a training dataset; the training dataset is used for offline training of a deep learning model. Those skilled in the art can understand that the super-resolution image may be obtained by any other technique, such as the single-molecule localization technique or stimulated emission depletion microscopy mentioned above. The dataset consisting of the super-resolution image obtained by any technique and the corresponding wide-field image can be used as a training dataset. The reconstruction quality of the deep learning model is tested. If the test is passed, the deep learning model and related learning parameters are saved. If the test fails, data analysis, super-resolution reconstruction analysis of structured illumination microscopy images, and retraining are performed. During the use of the deep learning model, the microscope system turns off the structured illumination device, loads the deep learning model, and performs super-resolution imaging by acquiring the wide-field image. In an example, for a specific model—that is, a model with fixed hardware parameters, the following process will be employed to achieve super-resolution effects. Those skilled in the art can understand that the following examples use structured illumination microscopy technology to obtain the super-resolution image, and other super-resolution image acquisition methods, such as single-molecule localization technology or stimulated emission depletion microscopy, can be used as alternatives to structured illumination microscopy technology to obtain the super-resolution image.
1) In a training phase, first, the optical path of the structured illumination module is coupled between the light source and objective lens of the original non-super-resolution system. Compared to the original system, a module for generating structured illumination is added, while other components that determine the optical system are not changed, thus ensuring compatibility. Next, based on this module, six types of structured light are generated in two directions, with three groups of phase shifts for each direction, and are projected successively onto one and the same area for the same run of reaction. That is, the original one-time imaging process of biochemical reaction-one-time image taking->removal is replaced by six-time image taking to obtain six original images. Each original image corresponds to one of the six types of structured illuminations, respectively. The six original images generated by this method are added to obtain a wide-field image (equivalent to the picture taken once by the non-super-resolution method), and a super-resolution image is reconstructed by a standard algorithm. This process is repeated to collect data from multiple runs of biochemical reactions to form a rich dataset, namely obtaining the training set and test set of the model.
2) In a testing phase, a wide-field image is selected from the test set, the corresponding super-resolution image obtained through the trained model is compared with the super-resolution image reconstructed by the standard algorithm, and when the similarity reaches a certain level, the model training is considered complete.
3) In actual use, first this super-resolution module is removed from the sequencing system. Since a one-to-one correspondence has been formed for the trained model and the optical system, the process from a single wide-field image input to a super-resolution image output can be completed. The corresponding biochemical process returns to the process of biochemical reaction→one-time image taking→removal, but from the low-resolution wide-field image obtained by this image taking, a high-resolution image can be obtained through the trained model, thereby achieving super-resolution effects.

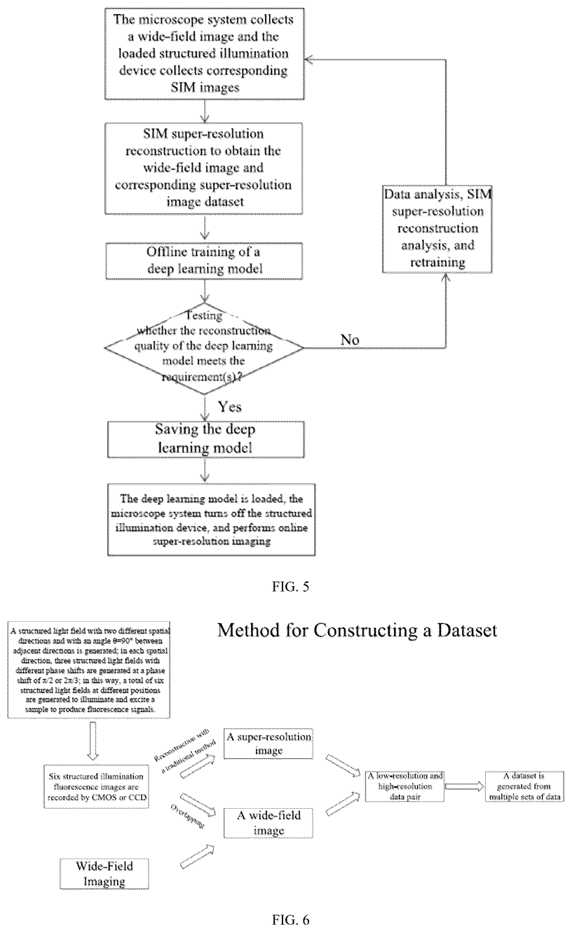

FIG. 6 shows a schematic diagram of a method for constructing a training dataset according to an embodiment of the present application. As shown in the figure, a structured light field with two different spatial directions and with an angle 0-90° between adjacent directions is generated; in each spatial direction, three structured light fields with different phase shifts are generated at a phase shift of π/2 or 2π/3; in this way, a total of six structured light fields at different positions are generated to illuminate and excite a sample to produce fluorescence signals. Therefore, in the present application, structured illumination is non-uniform illumination in which the distribution of light has a specific structure. In the present application, six structured illumination fluorescence images can be recorded by CMOS or CCD sensors. In the present application, a low-resolution and high-resolution data pair is a data pair consisting of a super-resolution image and a wide-field image. The specific generation method is as follows: the image of wide-field imaging is used as the low-resolution image, and the image generated by reconstruction of the six original images of structured illumination by the OpenSim algorithm is used as the high-resolution image. The low-resolution image and the high-resolution image constitute the dataset. The data contain images excited by red and green light. For example, the low-resolution image has the size of 48*48 and the high-resolution image has the size of 96*96. Multiple sets of data pairs form a dataset as the input dataset of the deep learning model, and the size of the dataset is usually greater than 200,000 pairs.

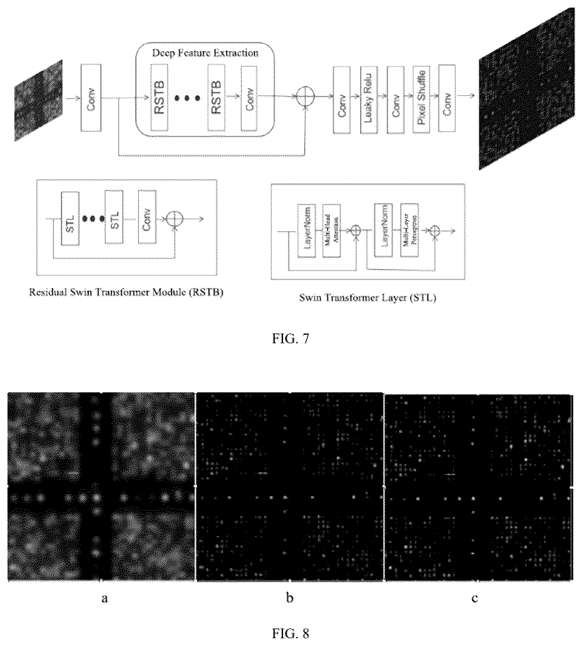

FIG. 7 shows an exemplary deep learning model used in an embodiment of the present application adopting a Transformer-based architecture. As shown in FIG. 7, the deep learning model comprises three parts: shallow feature extraction, deep feature extraction and upsampling reconstruction, which are implemented by a shallow feature extraction module, a deep feature extraction module and a reconstruction module respectively. The first convolutional layer is for shallow feature extraction, the middle deep feature extraction module is for deep feature extraction, and the rest is for upsampling reconstruction. This deep model adopts the [4,2,2,2] structure, that is, there are 4 RSTB blocks, the first RSTB has 4 STLs, and each of the other three RSTBs is composed of 2 STLs. The window size is 8. The shallow feature extraction mainly comprises low-frequency components, and the deep feature extraction module is configured to restore high-frequency components. Through the jump link of the shallow feature extraction layer, the low-frequency components and high-frequency components are input into the reconstruction module composed of a convolution layer and a Pixel Shuffle layer to reconstruct a high-resolution image. Shallow feature extraction is performed by a 3*3 convolutional layer. The deep feature extraction module consists of multiple residual Swin Transformer modules (RSTBs) and a 3*3 convolutional layer. Each RSTB consists of L Swin Transformer layers (STLs). Let the result of the j-th STL in the i-th RSTB be Fi,j, and the j-th STL is denoted by HSwin i,j( ) then Fi,j-HSwin i,j(Fi,j−1). The last layer of each RSTB is a convolutional layer, denoted by HCONVi( ) and then the residual connection is performed, so Fi,out=HCONVi Fi,L)+Fi,0.

Through this process, the corresponding dataset model for an ordinary wide-field image and a super-resolution image is established. Through verification testing, as long as the hardware system affecting this model remains unchanged, a wide-field image can be directly collected in the future and a super-resolution image can be generated directly through this model.

The method of the present application is compatible with the existing non-super-resolution methods, and a non-super-resolution system can also produce super-resolution effects, with the only need of importing a trained model into the system before the same leaves the factory. The traditional method requires actual acquisition of six stripe structured illumination images, while with this method, only one wide-field image needs to be collected, which improves the time utilization rate by 5/6. The present application can be applied to any super-resolution imaging field. The method of the present application is not limited to the fields of fluorescence imaging and gene sequencing, but is workable for all systems that achieve super-resolution effects based on structured illumination.

In an example of the present application, the method of the present application is adopted, using a group of 6 super-resolution images, which are first reconstructed using a traditional super-resolution reconstruction algorithm to form a deep learning model for this system, and then a wide-field image is input to directly obtain the corresponding super-resolution image. The deep learning model based on the Transformer architecture is as shown in FIG. 7. The data collection method is as follows: a wide-field image and a corresponding super-resolution image obtained by structured illumination microscopy (the size, width and height are twice the size, width and height of the wide-field image, respectively) are obtained, and the images are divided into 200,000 sets of low-resolution and high-resolution sub-data pairs. The size of the low-resolution images and the size of the high-resolution images are 48*48 and 96*96, respectively. The training data and test data in this example are grayscale images with fluorescence excitation of DNA nanoballs (DNBs) on the chip with a spacing of 360 nm, collected by a CMOS camera. The fluorescence excitation wavelengths include two wavelengths of 670 nm-700 nm and 550 nm-580 nm. The numerical aperture NA of the microscope is 0.8. The specific training process is as follows: the Adam optimization algorithm is used to perform training on the training set containing 200,000 pairs of low-resolution images and high-resolution images, and the training set is traversed at least 100 times, wherein the size of a small batch traversed each time for optimization of the network is 32, and the initial learning rate is 0.0002; the loss function used is L1 norm loss and L2 regularization, with weights of 1 and 1e-5 respectively; in order to make the error converge to a smaller value, the learning rate decay strategy is used to reduce the learning rate when the training error is stable. The training process is implemented using TRX 3090; the prediction process is directly performing reconstruction for the wide-field image based on the trained model.

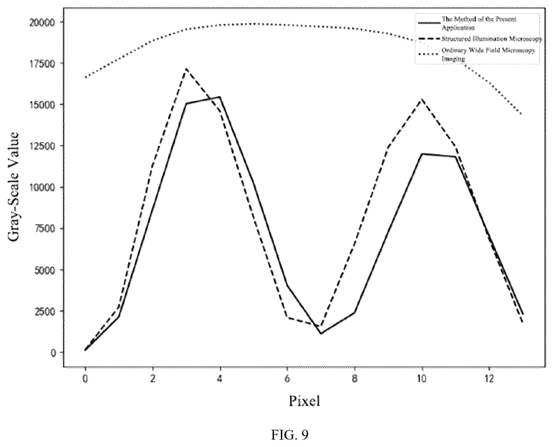

FIG. 8 exemplarily shows that a wide-field image (a. ordinary wide-field microscopy) is input into a trained deep learning model, and the corresponding super-resolution image (c) is output; wherein b is a structured illumination microscopy super-resolution image for comparison. FIG. 9 exemplarily shows a comparison of the imaging resolution performance of different methods under the same imaging condition. As shown in FIG. 8, the imaging results are illustrated by way of example. As compared with ordinary wide-field microscopy imaging, the method of the present application can effectively improve the imaging resolution, and is comparable to the traditional method as to the imaging quality. As shown in FIG. 9, a certain area is randomly selected and its grayscale distribution curve is plotted; it can be seen that the resolution of the method of the present application is comparable to that of the traditional method, and two adjacent DNBs can be clearly separated.

As shown in the reference table, Structural Similarity (SSIM) and Correlation Coefficient (CC) are used to measure the imaging quality of the method of the present application, and their index ranges are both from 0 to 1, with a high value indicating a high similarity. Specifically, in this example, the SSIM value between the imaging results of the method of the present application and the traditional method is 0.892, and the CC value is 0.904, quantitatively indicating the high consistency of the imaging results of the two methods. The Peak Signal to Noise Ratio (PSNR) is also used to evaluate the performance of the imaging results. Specifically, in this example, the PSNR between the method of the present application and the traditional method is 30.13 dB, which once again proves the effectiveness of the method of the present application.

| | | |
|---|---|---|
| index | the traditional method | the method of the |
| | | present application |
| the number of input image(s) | six SIM original images of | one wide-field image |
| | structured illumination | |

| | |
|---|---|
| structural similarity (SSIM) | 0.892 |
| correlation coefficient (CC) | 0.904 |
| peak signal to noise ratio (PSNR) | 30.13 dB |

The technical features described above can be combined arbitrarily. Although not all possible combinations of these technical features are described, any combination of these technical features should be considered to be covered by this specification as long as there is no contradiction in such combination.

Those skilled in the art should understand that the embodiments of the present application may be provided as a system or a computer program product. Therefore, the present application may take the form of a pure hardware embodiment, a pure module embodiment, or an embodiment combining module and hardware aspects. Moreover, the present application may take the form of a computer program product implemented on one or more computer-usable storage media (including but not limited to a disk memory, CD-ROM, optical memory, etc.) containing computer-usable program codes.

The present application is described with reference to flowcharts and/or block diagrams of methods, devices (systems), and computer program products according to embodiments of the present application. It should be understood that each process and/or block in the flowcharts and/or block diagrams, and a combination of the processes and/or blocks in the flowcharts and/or block diagrams can be implemented by computer program instructions. These computer program instructions can be provided to a processor of a general-purpose computer, a special-purpose computer, an embedded processor or other programmable data processing device to produce a machine, so that the instructions executed by the processor of the computer or other programmable data processing device produce a device for implementing the function specified in one or more processes in the flowcharts and/or in one or more blocks in the block diagrams.

These computer program instructions may also be stored in a computer-readable memory that can direct a computer or other programmable data processing device to work in a specific manner, so that the instructions stored in the computer-readable memory produce a manufactured product including an instruction device that implements the function specified in one or more processes in the flowcharts and/or in one or more blocks in the block diagrams.

These computer program instructions may also be loaded onto a computer or other programmable data processing device so that a series of operational steps are executed on the computer or other programmable device to produce computer-implemented processing, whereby the instructions executed on the computer or other programmable device provide steps for implementing the function specified in one or more processes in the flowcharts and/or in one or more blocks in the block diagrams.

In a typical configuration, a computing device comprises one or more processors (CPUs), input/output interfaces, a network interface, and a memory.

The memory may be in the form of a non-permanent memory, a random access memory (RAM) and/or a non-volatile memory of computer-readable media, such as a read-only memory (ROM) or flash RAM. A memory is an example of a computer-readable medium.

Computer-readable media comprise both permanent and non-permanent, removable and non-removable media, and can achieve storage of information by any method or technology. The information may be computer-readable instructions, data structures, program modules or other data. Examples of computer storage media include, but are not limited to, phase change memory (PRAM), static random access memory (SRAM), dynamic random access memory (DRAM), other types of random access memories (RAMs), read-only memory (ROM), electrically erasable programmable read-only memory (EEPROM), flash memory or other memory technology, compact disk read-only memory (CD-ROM), digital versatile disk (DVD) or other optical memories, magnetic cassettes, magnetic disk storage or other magnetic storage devices, or any other non-transmission medium that can be used to store information that can be accessed by a computing device. According to the definition herein, computer-readable media do not include temporary computer-readable media (transitory media), such as modulated data signals and carrier waves.

It should also be noted that the terms “comprise”, “include”, or any other variations thereof are intended to cover non-exclusive inclusion, such that a process, method, commodity, or apparatus that includes a series of elements includes not only those elements, but also other elements not explicitly listed, or also includes elements inherent to such a process, method, commodity, or apparatus. In the absence of more constraints, an element defined by the phrase “comprising a . . . ” does not exclude the existence, in the process, method, product or apparatus comprising the element, of a further identical element.

Although the present application has been described in conjunction with the embodiments, those skilled in the art should understand that the above description and drawings are merely illustrative but not limitative, and the present application is not limited to the disclosed embodiments. Various modifications and variations are possible without departing from the spirit of the present application.

1. A super-resolution analysis system, comprising an analysis unit, the analysis unit comprising a super-resolution realization model, the analysis unit being capable of being executed by a processor for constructing a super-resolution image based on an input wide-field image, wherein the super-resolution realization model is a trained deep learning model, and a training dataset for training the super-resolution realization model and the input wide-field image originate from one and the same imaging module.

2. The analysis system according to claim 1, the analysis unit comprising:
a receiving module configured for receiving the wide-field image from the imaging module;
a processing module connected to the receiving module, and configured for implementing the super-resolution realization model and constructing the super-resolution image based on the wide-field image.

3. The analysis system according to claim 2, the processing module comprising a processor and a memory, the memory being loaded with code for implementing the super-resolution realization model.

4. The analysis system according to claim 2, the receiving module communicating with the imaging module via a wired interface or a wireless interface.

5. The analysis system according to claim 1, the deep learning model adopting a Transformer architecture and comprising a shallow feature extraction module, a deep feature extraction module and a reconstruction module, the shallow feature extraction module being configured for extracting low-frequency components of an image, the deep feature extraction module being configured for restoring high-frequency components of an image, and the reconstruction module being configured for reconstructing a high-resolution image.

6. An imaging device, comprising an imaging module and the analysis system according to claim 1, the super-resolution realization model being trained with a training dataset from the imaging module.

7. The imaging device according to claim 6, the imaging module comprising a fluorescence microscope system, which emits laser light to a sample through a laser to excite the sample to generate fluorescence, to collect the wide-field image.

8. The imaging device according to claim 7, the imaging device being a sequencer, and the training dataset comprising wide-field images and super-resolution images generated respectively for different bases.

9. A super-resolution analysis method, comprising:
1) obtaining a wide-field image from an imaging module;
2) constructing a super-resolution image based on the wide-field image through a super-resolution realization model, wherein the super-resolution realization model is a trained deep learning model, and a training dataset for training the super-resolution realization model originates from the imaging module.

10. The method according to claim 9, the deep learning model adopting a Transformer architecture and comprising a shallow feature extraction module, a deep feature extraction module and a reconstruction module, the shallow feature extraction module being configured for extracting low-frequency components of an image, the deep feature extraction module being configured for restoring high-frequency components of an image, and the reconstruction module being configured for reconstructing a high-resolution image.

11. A training method for a super-resolution realization model, the method comprising:
1) obtaining at least one set of wide-field images and super-resolution images from an imaging module to form a training dataset;
2) completing training of feature parameters of a deep learning model based on the training dataset, and obtaining a super-resolution realization model for the imaging module based on trained feature parameters.

12. The method according to claim 11, the super-resolution images being obtained by:
1) collecting fluorophore signals of a target sample over time using single-molecule localization technology, and creating a super-resolution image by integrating the fluorophore signals;
2) constructing phase and amplitude images for a target sample in a wide-field light source using structured illumination microscopy, and creating a super-resolution image by integrating multiple phase and amplitude images; or
3) exciting fluorescence from a target sample by two lasers through stimulated emission depletion microscopy, wherein one of the two lasers is operated to excite fluorophore(s) and the other is operated to emit a laser beam to deplete emission from the same fluorophore(s), thereby forming images of local captured areas, and creating a super-resolution image by integrating the images of local captured areas.

13. The method according to claim 12, for the structured illumination microscopy, the super-resolution image being created by integrating six phase and amplitude images.

14. The method according to claim 13, phases of the six phase and amplitude images being respectively as follows: in the X direction: φ_{X1}: 0, φ_{X2}: 2π/3, φ_{X3}; 4π/3; in the Y direction: φ_{Y1}: 0, φ_{Y2}: 2π/3, φ_{Y3}: 4π/3.

15. The imaging device according to claim 6, the analysis unit comprising:
a receiving module configured for receiving the wide-field image from the imaging module;
a processing module connected to the receiving module, and configured for implementing the super-resolution realization model and constructing the super-resolution image based on the wide-field image.

16. The imaging device according to claim 15, the processing module comprising a processor and a memory, the memory being loaded with code for implementing the super-resolution realization model.

17. The imaging device according to claim 15, the receiving module communicating with the imaging module via a wired interface or a wireless interface.

18. The imaging device according to claim 6, the deep learning model adopting a Transformer architecture and comprising a shallow feature extraction module, a deep feature extraction module and a reconstruction module, the shallow feature extraction module being configured for extracting low-frequency components of an image, the deep feature extraction module being configured for restoring high-frequency components of an image, and the reconstruction module being configured for reconstructing a high-resolution image.
